(19) United States
(12) Patent Application Publication
(10) Pub. No.: US 2025/0236215 A1
(43) Pub. Date: Jul. 24, 2025

(54) SYSTEM FOR VEHICLE PASSENGER SEAT CARGO SETTINGS AND RELATED METHODS

(71) Applicant: TOYOTA MOTOR ENGINEERING & MANUFACTURING NORTH AMERICA, INC., Plano, TX (US)

(72) Inventor: Lisa L. Maitre, Milford, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/419,967

(22) Filed: Jan. 23, 2024

(51) Int. Cl. B60N 2/02; B60R 7/04

(52) U.S. Cl. CPC B60N 2/0248; B60R 7/04

(57) ABSTRACT

A system to automatically adjust a vehicle passenger seat and/or center console to a cargo position which makes it more comfortable/ergonomic to place cargo into the seat and/or retrieve the cargo from the scat.

### TECHNICAL FIELD

The subject matter described herein relates generally to improving the comfort for vehicle drivers and, more particularly, to systems and methods for automatically adjusting a passenger cargo seat of a vehicle. This technology has particular but not exclusive utility for consumer and commercial cars and trucks.

### BACKGROUND

It is common for a driver or other passenger to place their bags or other cargo on the passenger seat as they enter a vehicle to commute to and from various locations, such as work. It can be difficult (if not impossible depending on the reach required and the weight of the bags) to lift the cargo when exiting the vehicle. Moreover, the size (height and width) of the vehicle or center console make it even harder to place into or retrieve cargo out of the passenger seat. As a result, the driver often has to exit the vehicle and open the passenger door in order to retrieve the cargo from the passenger seat, thus wasting precious time.

### SUMMARY

The various embodiments described herein provide a solution to the comfort and time waste issue of conventional vehicles, as it relates to the depositing and retrieval of cargo to/from passenger seats. A general embodiment of the present disclosure provides a system for adjusting a passenger cargo seat or center console of a vehicle. The system includes a vehicle having a driver seat and a passenger seat, along with a center console. A processor comprises a memory and is configured to perform operations which comprise: obtaining a user profile for locating cargo on the passenger seat of the vehicle, the user profile corresponding to a seat position of the passenger seat or cargo position of the center console; and based on the user profile, automatically adjusting the passenger seat or center console to a cargo setting such that cargo located on the passenger seat is accessed more comfortably.

The passenger seats or center console can be adjusted in a variety of ways: the seats can be adjusted to the cargo setting when a driver approaches, enters or exits the vehicle, when the vehicle is parked or approaches a parking space, or when a driver shuts off the engine. A database may be used for storing multiple user profiles which correspond to passenger seat positions or center console positions. In yet other embodiments, after the cargo is retrieved from the vehicle, the system automatically adjusts the passenger seat to a passenger setting, the passenger setting being different from the cargo setting.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the passenger cargo seat adjustment system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a diagrammatic illustration of a vehicle including a cargo seat adjustment system, in accordance with at least one embodiment of the present disclosure.

FIG. 2 is a diagrammatic illustration, in a block-diagram form, of at least a portion of the cargo seat adjustment system of FIG. 1, in accordance with at least one embodiment of the present disclosure.

FIG. 3 illustrates the interior of a vehicle having a cargo seat adjustment system of the present disclosure.

FIG. 4 is a flow chart of a method for adjusting a passenger seat of the vehicle, in accordance with at least one embodiment of the present disclosure.

FIG. 5 is a schematic diagram of a processor circuit, in accordance with at least one embodiment of the present disclosure.

### DETAILED DESCRIPTION

The present disclosure is generally directed to automatic adjustment of a passenger seat of a vehicle in which cargo has been placed. Aspects of the present disclosure are directed to improving the ergonomic placement or extraction of items from a passenger seat by a passenger when they enter or exit the vehicle. A driver may place their bags, purse, laptop, lunch bag, or the like on the passenger seat as they enter the car. However, it can be difficult depending on the reach required, the height of a center console, and the weight of the bags to deposit or lift the items from the passenger seat when the driver enters or exits the vehicle.

Accordingly, illustrative embodiments of the present disclosure provide systems and methods to create and obtain a profile seat position for the passenger seat which enables easy, ergonomic access to cargo located on the passenger seat. The cargo profile seat position can be pre-selected based on a driver profile or directly for the passenger seat. In addition, the user can set profile positions for the center console to further aid the case of depositing or retrieving cargo from the passenger seat. The illustrative methods provided herein make the cargo easier to access by having a pre-set position (e.g., a seat height raised, seat cushion tilt, seat back reclined, or the like) to make it easier and more ergonomic to place or remove bags from either the driver side or passenger door side.

The passenger cargo seat adjustment system described herein may be implemented as a process at least partially viewable on a display, and operated by a control process executing on a processor that accepts user inputs from a suitable user-interface and other control devices, and that is in communication with one or more vehicle sensors. In that regard, the control process performs certain specific operations in response to different inputs or selections made at different times, and/or in response to real-time or near-real-time sensor readings.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the passenger cargo seat adjustment system described herein. Certain features may be added, removed, or modified without departing from the spirit of the claimed subject matter.

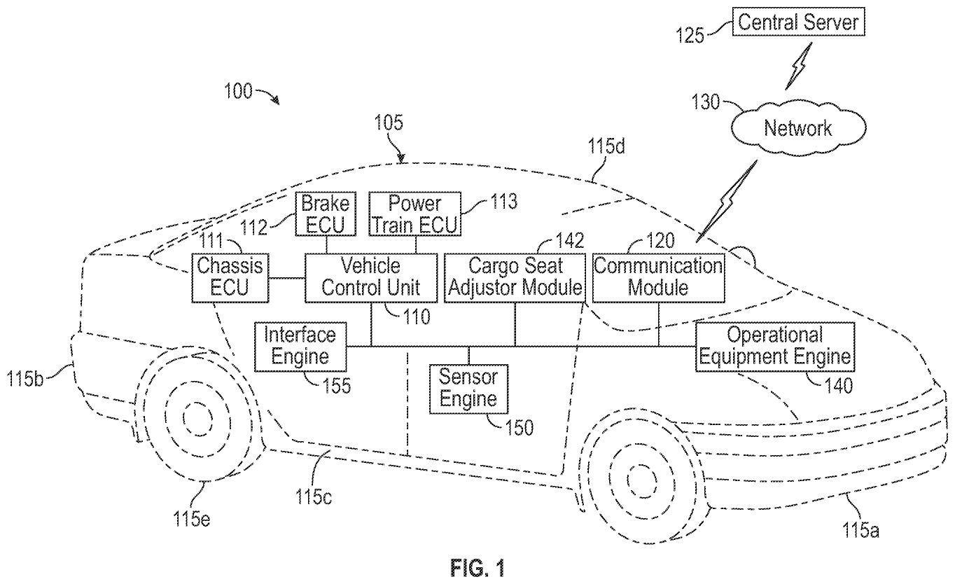

FIG. 1 is a diagrammatic illustration of a passenger cargo seat adjustment system in accordance with at least one embodiment of the present disclosure. In an example, a passenger cargo seat adjustment system is referred to by the reference numeral 100 and includes a vehicle 105, such as an automobile, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e. A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, route or path, and topography information.

An operational equipment engine 140 is operably coupled to, and adapted to be in communication with, the vehicle control unit 110 and cargo seat adjustor 142 which is utilized to perform the methods described herein. A sensor engine 150 is operably coupled to, and adapted to be in communication with, the vehicle control unit 110. The sensor engine 150 is adapted to monitor various components of, for example, the operational equipment engine 140, as will be described in further detail below. An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of the cargo seat adjustment system 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, or transmission ECU) that controls elements of the motor 195 and drivetrain 200, and sensor engine 150.

A reader of ordinary skill in the art will understand that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110.

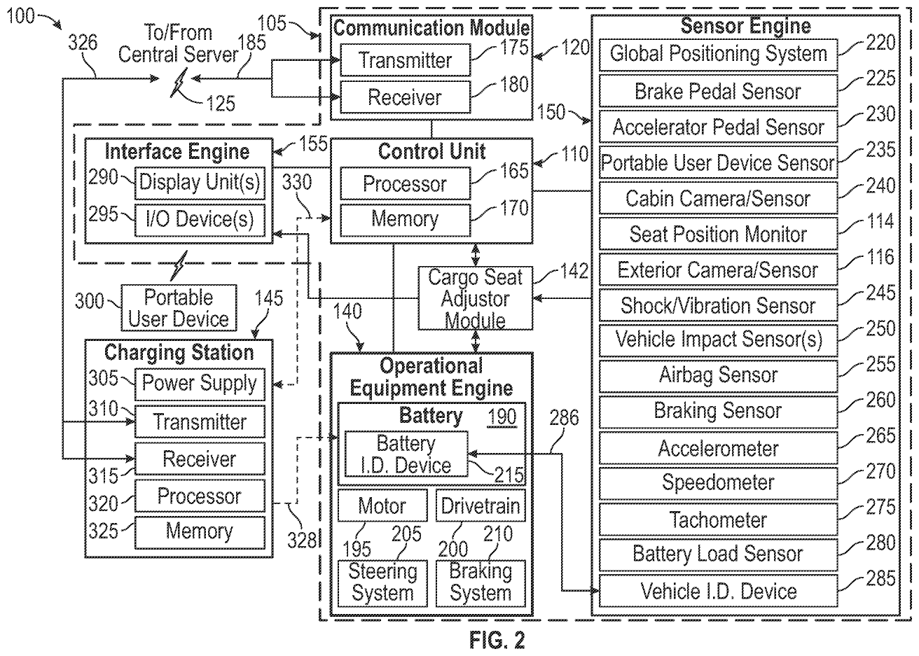

FIG. 2 is a diagrammatic illustration, in a block-diagram form, of at least a portion of the cargo seat adjustment system 100 of FIG. 1, in accordance with at least one embodiment of the present disclosure. It is worth noting that the components of the vehicle 105 may be located either permanently or temporarily as a part of the vehicle 105. The vehicle control unit (VCU) 110 includes a processor 165 and a memory 170. In some examples, the communication module 120, which is operably coupled to, and adapted to be in communication with, the vehicle control unit 110, includes a transmitter 175 and a receiver 180. In some examples, one or the other of the transmitter 175 and the receiver 180 may be omitted according to the particular application for which the communication module 120 is to be used. In other examples, the transmitter 175 and receiver 180 are combined into a single transceiver that performs both transmitting and receiving functions.

In some examples, the operational equipment engine 140, which is operably coupled to, and adapted to be in communication with, the vehicle control unit 110, includes a plurality of devices configured to facilitate driving of the vehicle 105. In this regard, the operational equipment engine 140 may be designed to exchange communication with the vehicle control unit 110, so as to not only receive instructions, but to provide information on the operation of the operational equipment engine 140. For example, the operational equipment engine 140 may include a vehicle battery 190, a motor 195, a drivetrain 200, a steering system 205, and a braking system 210. In some vehicles, the vehicle battery 190 may provide electrical power to the motor 195 to drive the wheels 115e of the vehicle 105 via the drivetrain 200. In some examples, instead of or in addition to providing power to the motor 195 to drive the wheels 115e of the vehicle 105 via the drivetrain or transmission 200, the vehicle battery 190 provides electrical power to another component of the operational equipment engine 140, the vehicle control unit 110, the communication module 120, the sensor engine 150, the interface engine 155, or any combination thereof. In some examples, the vehicle battery 190 includes a battery identification device 215. The battery identification device 215 is adapted to communicate with one or more components of the sensor engine 150, and stores data identifying the vehicle battery 190 such as, for example, manufacturing information (e.g., production date, production facility, etc.), battery characteristic(s) information, battery identification number information, electric vehicle compatibility information, or the like. In some embodiments, the motor is an internal combustion motor and the battery operates a starter.

In some examples, the sensor engine 150, which is operably coupled to, and adapted to be in communication with, the vehicle control unit 110, includes devices such as sensors, meters, detectors, or other devices configured to measure or sense a parameter related to a driving operation of the vehicle 105 or the position of a user entering or exiting vehicle 105. For example, the sensor engine 150 may include a global positioning system 220 that can be used to determine road grade, a brake pedal sensor 225, an accelerator pedal sensor 230, a portable user device sensor 235 that can be used to determine when a certain driver is in the vicinity or inside vehicle 105, a cabin camera/sensor 240 used to monitor the position of persons within vehicle 105, a seat position monitor 114 used to control and monitor the position of the vehicle seats, a shock/vibration sensor 245, a vehicle impact sensor 250, an airbag sensor 255, a braking sensor 260, an accelerometer 265 (which may in some cases also serve as an inclinometer), a speedometer 270, a tachometer 275, a battery load sensor 280, a vehicle identification device 285, an exterior camera or sensor 116 that can be used to monitor traffic and/or weather conditions around the vehicle or to determine when vehicle 105 approaches a parking space, or any combinations thereof. In some instances, traffic or weather patterns may be monitored from outside the vehicle and received from a server via a network.

The sensors or other detection devices may be configured to sense or detect activity, conditions, and circumstances in an area to which the device has access, e.g., ambient conditions, conditions within the vehicle cabin, etc. Sub-components of the sensor engine 150 may be deployed at any operational area where information on the driving of the vehicle 105 may occur. Some readings from the sensor engine 150 may be fed back to the vehicle control unit 110. Stored and reported performance data may include the sensed data, or may be derived, calculated, or inferred from sensed data. The vehicle control unit 110 may send signals to the sensor engine 150 to adjust the calibration or operating parameters of the sensor engine 150 in accordance with a control program in the vehicle control unit 110. The vehicle control unit 110 is adapted to receive and process performance data from the sensor engine 150 or from other suitable source(s), and to monitor, store (e.g., in the memory 170), and/or otherwise process (e.g., using the processor 165) the received performance data.

The braking sensor 260 is adapted to monitor usage of the vehicle 105's braking system 210 (e.g., an antilock braking system 210) and to communicate the braking information to the vehicle control unit 110. The accelerometer 265 is adapted to monitor acceleration of the vehicle 105 and to communicate the acceleration information to the vehicle control unit 110. The accelerometer 265 may be, for example, a two-axis accelerometer 265 or a three-axis accelerometer 265, and may also serve as an inclinometer or tilt sensor. In some examples, the accelerometer 265 is associated with an airbag of the vehicle 105 to trigger deployment of the airbag. The speedometer 270 is adapted to monitor speed of the vehicle 105 and to communicate the speed information to the vehicle control unit 110. In some examples, the speedometer 270 is associated with a display unit of the vehicle 105 such as, for example, a display unit of the interface engine 155, to provide a visual indication of vehicle speed to a driver of the vehicle 105. The tachometer 275 is adapted to monitor the working speed (e.g., in revolutions-per-minute) of the vehicle 105's motor 195 and to communicate the angular velocity information to the vehicle control unit 110. In some examples, the tachometer 275 is associated with a display unit of the vehicle 105 such as, for example, a display unit of the interface engine 155, to provide a visual indication of the motor 195's working speed to the driver of the vehicle 105. The battery load sensor 280 is adapted to monitor charging, discharging, and/or overcharging of the vehicle battery 190 and to communicate the charging, discharging, and/or overcharging information to the vehicle control unit 110.

In some examples, the vehicle identification device 285 stores data identifying the vehicle 105 such as, for example, manufacturing information (e.g., make, model, production date, production facility, etc.), vehicle characteristic(s) information, vehicle identification number (“VIN”) information, battery compatibility information, or the like. The vehicle identification device 285 is adapted to communicate with the battery identification device 215 (or vice versa), as indicated by arrow 286. In some examples, the vehicle identification device 285 and the battery identification device 215 may each communicate with the vehicle control unit 110.

In some examples, the interface engine 155, which is operably coupled to, and adapted to be in communication with, the vehicle control unit 110, includes at least one input and output device or system that enables a user to interact with the vehicle control unit 110 and the functions that the vehicle control unit 110 provides. Thus, the user can enter user profile information for the passenger seat position when locating cargo on the passenger seat of the vehicle, as will be described herein. For example, the interface engine 155 may include a display unit 290 and an input/output (“I/O”) device 295. The display unit 290 may be, include, or be part of multiple display units. In some examples, the display unit 290 may include one, or any combination, of a central display unit associated with a dash of the vehicle 105, an instrument cluster display unit associated with an instrument cluster of the vehicle 105, and/or a heads-up display unit associated with the dash and a windshield of the vehicle 105; accordingly, as used herein the reference numeral 290 may refer to one, or any combination, of the display units. The I/O device 295 may be, include, or be part of a communication port (e.g., a USB port), a Bluetooth communication interface, a touch-screen display unit, soft keys associated with a dash, a steering wheel, or another component of the vehicle 105, and/or similar components. Other examples of sub-components that may be part of the interface engine 155 include, but are not limited to, audible alarms, visual alerts, telecommunications equipment, and computer-related components, peripherals, and systems.

In some examples, a portable user device 300 belonging to an occupant of the vehicle 105 may be coupled to, and adapted to be in communication with, the interface engine 155. For example, the portable user device 300 may be coupled to, and adapted to be in communication with, the interface engine 155 via the I/O device 295 (e.g., the USB port and/or the Bluetooth communication interface). In an example, the portable user device 300 is a handheld or otherwise portable device which is carried into the vehicle 105 by a user who is a driver or a passenger on the vehicle 105. In addition, or instead, the portable user device 300 may be removably connectable to the vehicle 105, such as by temporarily attaching the portable user device 300 to the dash, a center console, a seatback, or another surface in the vehicle 105. In another example, the portable user device 300 may be permanently installed in the vehicle 105. In some examples, the portable user device 300 is, includes, or is part of one or more computing devices such as personal computers, personal digital assistants, key fobs, cellular devices, mobile telephones, wireless devices, handheld devices, laptops, audio devices, tablet computers, game consoles, cameras, and/or any other suitable devices. In several examples, the portable user device 300 is a smartphone such as, for example, an iPhone® by Apple Incorporated.

The cargo seat adjustment system 100 also includes a cargo seat adjustor 142, the operation of which will be described below. In some embodiments, the cargo seat adjustor 142 is a module communicably coupled to the vehicle front passenger seat (and other seats, in some embodiments), and may also includes its own processor and memory. As described herein, the cargo seat adjustor 142 enables the automatic adjustment of the cargo seat (passenger seat in which the cargo is placed) and center console based upon a user profile. To achieve this, the cargo seat adjustor 142 is in communication with one or more of the sensor engine 150, VCU 110, operational equipment engine 140, or interface engine 155.

A reader of ordinary skill in the art will understand that other components or arrangements of components may be found in a vehicle 105, and that may of the same general principles apply to electric vehicles, internal combustion vehicles, and hybrid vehicles.

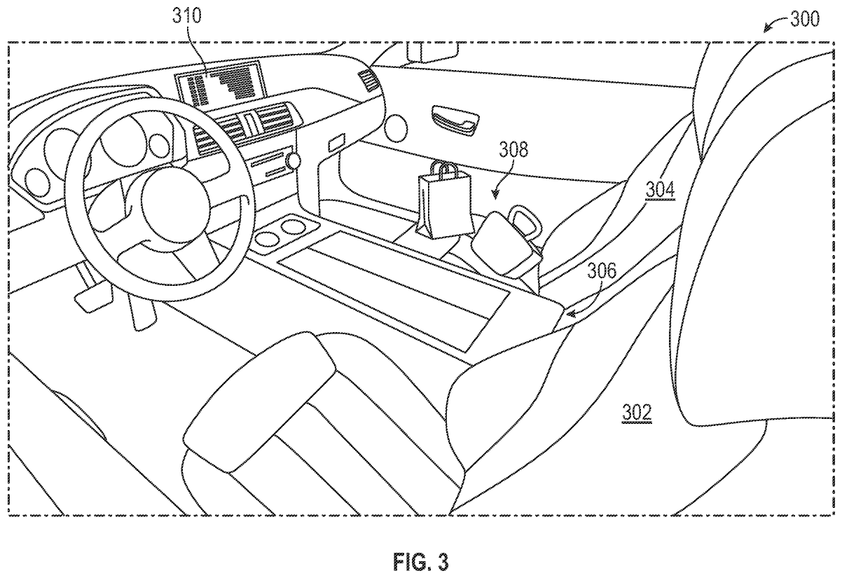

FIG. 3 is a representation of the interior cabin of vehicle 105, in accordance with at least one embodiment of the present disclosure. Interior cabin 300 includes an adjustable drivers seat 302 and adjustable passenger seat 304 (also acting as the cargo seat), separated by an adjustable center console 306. Although not shown, driver and passenger seats 302/304 and center console 306 are all communicably coupled to cargo seat adjustor 142. During operation, when a driver is detected near vehicle 105 using portable user device sensor 235, cargo seat adjustor retrieves the user profile associated with that driver's portable device (e.g., key fob) or other suitable identifier or technique, and adjusts center console 306 and/or passenger seat 304 to allow easier and more comfortable/ergonomic placement or retrieval of cargo 308 in/from seat 304.

A user may create a driver profile in a variety of ways. For example, a user may create a profile via user interface 310 (e.g., a multimedia touchscreen). In other examples, the user interface may also be some remote device such as a smart phone. Using interface 310, the user may create a profile that saves one or more positions of passenger seat 304 and/or center console 306 that is comfortable for the user to place or retrieve cargo 308 into or from, respectively. Such profiles may have themes, such as a commuter theme that applies when the driver is traveling without a passenger in the front passenger seat, or a family theme that applies when the driver includes passengers. Any variety of themes can be added to the user profiles (commuter theme, family theme, rideshare, etc.). In some examples, the themes may have pre-selected cargo positions for passenger seat 304 or console 306, while in other examples the user will have to manually set those positions. Nevertheless, once the passenger seat 304 and/or console 306 has been adjusted to the desired setting, the user may save those positions under a given profile via user interface 310.

Although not shown, center console 306 and passenger seat 304 are moved using one or more powered mechanisms, also controlled by cargo seat adjustor 142. Those ordinarily skilled in the art having the benefit of this disclosure will realize there are a variety of suitable electro-mechanical designs for this purpose. Those powered mechanisms enable 360 degree movement that will position the center console 306 and seat 304 based upon the respective positions saved in the user profiles. For example, passenger seat 304 may be lifted higher or lower to make it easier for the driver to reach over and place cargo 308 on the seat or retrieve cargo 308 from the seat. In other embodiments, passenger seat 304 may be moved laterally closer to drivers seat 302 to shorten the distance between the driver and cargo 308. In yet other embodiments, the center console may be moved backwards toward the back seats or downward towards the floor of the vehicle in order to make it easier for the driver to reach cargo 308. Nevertheless, once the profiles have been saved to the system, cargo set adjustor 142, using the powered mechanisms, can thereafter adjust the passenger seat 304 and/or center console 306 automatically.

In yet other embodiments, passenger seat 304 could also be adjusted such that it flattens to allow it to be used as a desk or to enable transportation of very large cargo (e.g., lumber).

Cargo seat adjustor 142 can be activated in a variety of situations. For example, in conjunction with the figures previous described, as a user approaches vehicle 105 along with a portable user device 300 (e.g., key fob), cargo seat adjustment system 100 detects device 300 using portable user device sensor 235. Thereafter, control unit 110 works in conjunction with cargo seat adjustor 142 to retrieve a user profile corresponding to portable user device 300 from memory 170 (which, in this example, acts as a database for storing one or more user profiles). Cargo seat adjustment system 100 then adjusts passenger seat 304 and/or center console 306 to the position stored in the user profile. The seat adjustment can occur as the user (e.g., driver) approaches the vehicle, opens the door or enters the vehicle. In the case the user is a driver, the user can then position his or her cargo comfortably as they enter the vehicle. This same position of seat 304 and/or center console 306 can be maintained as the user drives at arrives at the destination. At this point, the user can then comfortably retrieve the cargo from the passenger seat 304 before the user exits the vehicle. In yet another alternate embodiment, the user may exit the vehicle, then open the passenger door and retrieve the cargo from outside the vehicle (in such a case, the user may have the same or a different seat position saved in the user's profile for this case).

In an alternative example, the user's portable device 300 may be detected in the same manner as previously described, but cargo seat adjustment system 100 will not adjust the position of passenger seat 304 and/or center console 306 until the system determines the user is about the exit the vehicle. Such determination may be made, for example, when vehicle 105 is put into a “park” gear, when the engine is shut off, or when the driver exits the vehicle. In another illustrative embodiment, cargo seat adjustment system 100 may adjust passenger seat 304 and/or center console 306 as the vehicle approaches a parking spot. Such a determination may be made, for example, using exterior camera/sensor 116. Such detection methods would be readily appreciated and understood by those ordinarily skilled in the art having the benefit of this disclosure.

In yet other embodiments, passenger seat 304 may be equipped with some apparatus to secure the cargo during travel. Such examples may include a cargo net or similar apparatus.

After the cargo 308 has been retrieved from passenger seat 304, in some embodiments, cargo seat adjustment system 100 may re-adjust passenger seat 304 and/or center console 306 back to a passenger seat setting (intended for use when a passenger sits in the seat). The passenger setting may or may not be different from the cargo setting. Cargo seat adjustment system 100 may activate to achieve this once the driver has left the vehicle and is no longer within a certain distance of the vehicle, for example.

It is noted that flow diagrams are provided herein for exemplary purposes; a person of ordinary skill in the art will recognize myriad variations that nonetheless fall within the scope of the present disclosure. For example, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, in order to adjust the cargo seat in real time, the cargo seat adjustment system 100 may need to execute multiple times per second (e.g., a rate of 10 Hz, 20 Hz, etc.).

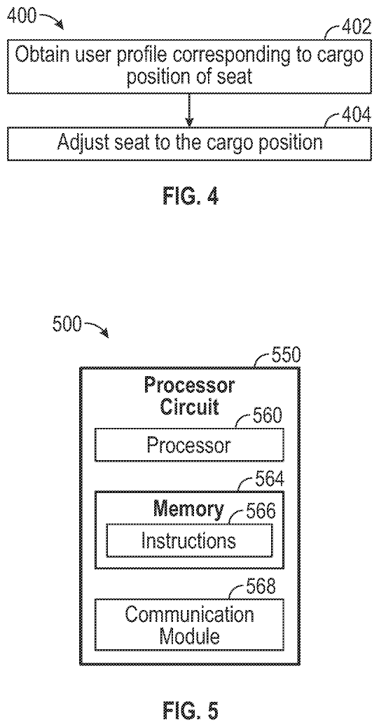

FIG. 4 is a flow diagram of the method to adjust a passenger cargo seat of a vehicle, according to illustrative embodiments of the present disclosure. A described herein in one example, cargo seat adjustment system 100 is communicably coupled to vehicle 105, which contains a processor, memory and the various other components described herein. At block 402 of method 400, cargo seat adjustment system 100 obtains a user profile for positioning cargo on the passenger seat of the vehicle, which may be entered and stored by the user via some suitable user interface. The user profile corresponds to one or more seat positions of the passenger seat the user desires. During operation, cargo seat adjustment system 100 can detect the presence of a driver using a portable device (or other suitable detection technique), which then activates cargo seat adjustment system 100 to adjust the passenger seat to position stored in the driver's user profile. Alternatively, cargo seat adjustment system 100 may be activated upon some event such as, for example, when the vehicle is parked or approaches a parking spot, as described herein. Nevertheless, once cargo seat adjustment system 100 is activated at block 402, cargo seat adjustment system 100 then automatically adjusts the passenger seat to a cargo setting which makes it comfortable cargo in the seat to be deposited in or removed from the seat. In yet other exemplary methods, the position of the center console can be stored in the user profile and adjusted in like manner.

FIG. 5 is a schematic diagram of a processor circuit 550, in accordance with at least one embodiment of the present disclosure. The processor circuit 550 may be implemented in the system 100, or other devices or workstations (e.g., third-party workstations, network routers, etc.), or on a cloud processor or other remote processing unit, as necessary to implement the methods described herein. As shown, the processor circuit 550 may include a processor 560, a memory 564, and a communication module 568. These elements may be in direct or indirect communication with each other, for example via one or more buses.

The processor 560 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 560 may also comprise another hardware device, a firmware device, or any combination thereof configured to perform the operations described herein. The processor 560 may also be implemented as a combination of computing devices, e.g., a combination of a DSP and a microprocessor, a plurality of microprocessors, one or more microprocessors in conjunction with a DSP core, or any other such configuration.

The memory 564 may include a cache memory (e.g., a cache memory of the processor 560), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 564 includes a non-transitory computer-readable medium. The memory 564 may store instructions 566. The instructions 566 may include instructions that, when executed by the processor 560, cause the processor 560 to perform the operations described herein. Instructions 566 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 568 can include any electronic circuitry and/or logic circuitry to facilitate direct or indirect communication of data between the processor circuit 550, and other processors or devices. In that regard, the communication module 568 can be an input/output (I/O) device. In some instances, the communication module 568 facilitates direct or indirect communication between various elements of the processor circuit 550 and/or the system 100. The communication module 568 may communicate within the processor circuit 550 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from vehicle or environmental sensors) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

The technology described herein may be implemented on manually controlled vehicles or driver-assist vehicles. The technology may be implemented in diverse combinations of hardware, software, and firmware, depending on the implementation or as necessitated by the structures and modules already present in existing vehicles. The system may be employed on vehicles with automatic transmission, manual transmissions, or vehicles with simulated shifting, including continuously variable transmission (CVT), infinitely variable transmission (IVT), hybrid transmissions (e.g., a hybrid vehicle with 4-speed automatic transmission simulating 10 gears), and fully electric vehicles.

Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the cargo seat adjustment system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the cargo seat adjustment system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system for adjusting a passenger cargo seat of a vehicle, the system comprising:
the vehicle having a driver seat and a passenger seat; and
a processor comprising a memory and configured to perform operations comprising:
obtaining a user profile for locating cargo on the passenger seat of the vehicle, the user profile corresponding to a seat position of the passenger seat; and
based on the user profile, automatically adjusting the passenger seat to a cargo setting such that cargo located on the passenger seat is positioned closer to the driver seat.

2. The system of claim 1, wherein the passenger seat is adjusted to the cargo setting when a driver approaches the vehicle.

3. The system of claim 1, wherein the passenger seat is adjusted to the cargo setting when the vehicle is parked.

4. The system of claim 1, wherein the passenger seat is adjusted to the cargo setting when a driver shuts off the engine.

5. The system of claim 1, wherein the passenger seat is adjusted to the cargo setting when a driver exits the vehicle.

6. The system of claim 1, further comprising a database for storing one or more user profiles corresponding to passenger seat positions for cargo of one or more drivers.

7. The system of claim 1, wherein:
the vehicle further comprises an adjustable center console between the driver and passenger seat;
the user profile corresponds to a position of the center console; and
based on the user profile, the system automatically adjusts the center console such that the cargo is accessible to the driver.

8. The system of claim 1, wherein, after the cargo is retrieved from the vehicle, the system automatically adjusts the passenger seat to a passenger setting, the passenger setting being different from the cargo setting.

9. A computer-implemented method for adjusting a passenger cargo seat of a vehicle, the method comprising:
obtaining a user profile for locating cargo on a passenger seat of the vehicle, the user profile corresponding to a seat position of the passenger seat; and
based on the user profile, automatically adjusting the passenger seat to a cargo setting such that cargo located on the passenger seat is positioned closer to a driver seat.

10. The computer-implemented method of claim 9, wherein the passenger seat is adjusted to the cargo setting when a driver approaches the vehicle.

11. The computer-implemented method of claim 9, wherein the passenger seat is adjusted to the cargo setting when the vehicle is parked.

12. The computer-implemented method of claim 9, wherein the passenger seat is adjusted to the cargo setting when a driver shuts off the engine.

13. The computer-implemented method of claim 9, wherein the passenger seat is adjusted to the cargo setting when a driver exits the vehicle.

14. The computer-implemented method of claim 9, wherein the user profile is obtained from a database for storing one or more user profiles corresponding to passenger seat positions for cargo of one or more drivers.

15. The computer-implemented method of claim 9, wherein:
the vehicle further comprises an adjustable center console between the driver and passenger seat;
the user profile corresponds to a position of the center console; and
based on the user profile, automatically adjusting the center console such that the cargo is accessible to the driver.

16. The computer-implemented method of claim 9, wherein, after the cargo is retrieved from the vehicle, the passenger seat is automatically adjusted to a passenger setting, the passenger setting being different from the cargo setting.

17. A method for adjusting a passenger seat of a vehicle, the method comprising:
obtaining a user profile for locating cargo on a passenger seat of the vehicle; and
based on the user profile, automatically adjusting at least one of a passenger seat or center console to a cargo setting such that cargo located on the passenger seat is accessible to a driver of the vehicle.

18. The method of claim 17, wherein the adjustment occurs when a driver:
approaches the vehicle; or
enters the vehicle.

19. The method of claim 17, wherein the adjustment occurs when:
the vehicle approaches a parking spot;
the vehicle is parked;
an engine of the vehicle is turned off; or
the driver exits the vehicle.

20. The method of claim 17, wherein, after the cargo is retrieved from the vehicle, at least one of the passenger seat or center console are automatically adjusted to a passenger setting, the passenger setting being different from the cargo setting.
